(19) United States
(12) Patent Application Publication
(10) Pub. No.: US 2015/0256678 A1
(43) Pub. Date: Sep. 10, 2015

(54) STANDARDIZATION OF PROCESS FOR RESOLVING INSTITUTION CALLS BASED ONTHE CUSTOMER REQUEST

(71) Applicant: Bank of America Corporation, Charlotte, NC (US)

(72) Inventors: Jose Federico Jarquin Murillo, San Jose (CR); Ana Camacho Alfaro, San Jose (CR)

(73) Assignee: Bank of America Corporation, Charlotte, NC (US)

(21) Appl. No.: 14/202,716

(22) Filed: Mar. 10, 2014

(51) Int. Cl. H04M 3/523

(52) U.S. Cl. CPC H04M 3/5235

(57) ABSTRACT

Systems, apparatus, methods, and computer program products are provided for standardizing call resolution of financial institution calls. A call advisor tool is described that insures that a consistent and efficient call resolution is provided each time a customer calls occurs. The call advisor tool provides for a simplistic approach to determining call resolution, such that the financial institution representatives can easily navigate and provide inputs to the tool to render a call resolution. The straightforward approach of the call advisor tool minimizes the inputs required of the financial institution representative to complete the call resolution process, resulting in decreases in call time.

### FIELD

In general, embodiments of the invention relate to financial institution customer calls and, more particularly, standardization of the process for resolving financial institution customer calls.

### BACKGROUND

Financial institutions, such as banks or the like, receive a high volume of calls, via a telephone call center or the like, from customers seeking answers to specific inquiries about their deposit accounts, credit/debit accounts or the like. The financial institution representatives, otherwise referred to as associates, that handle these calls are tasked with resolving the calls based on the specific inquiries posed by the customers. If the financial institution representative resolves the call without relying on any guidelines, the result is inconsistency of call resolution, i.e., one financial institution representative may provide one resolution to a specific call inquiry while another financial institution representative may provide a completely different resolution to the same specific call inquiry. In other instances in which the financial institution representative is provided with guidelines the guidelines themselves may be ineffective in assuring call resolution consistency. For example, if the call resolution solution is limited to a search engine, the information that is provided to the customer to resolve the call may vary depending on the search criteria provided by the financial institution representative. Moreover, if the call resolution solution is overly broad in scope the user may not be able to readily apply call inquiry criteria that results in call resolution consistency.

Therefore, a need exists to develop a systems, apparatus, computer program products and the like that provide a simplified process for standardizing call resolution of financial institution calls. The desired approach to call resolution should insure that a consistent resolution results such that customers presenting the same call request inquiry are provided the same call resolution. In addition, the desired approach to call resolution should be simplistic so that the financial institution representative is only required to provide minimal inputs to complete the call resolution process and such that the process minimizes the time needed to resolve the customer inquiry, thereby decreasing overall call time.

### SUMMARY OF THE INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing apparatus, computer program products or the like for standardizing call resolution of financial institution calls, specifically calls related to credit/debit cards, deposits or the like. The embodiments of the invention herein described insure that a consistent and efficient call resolution is provided each time a customer calls results. In this regard, customers who call with the same call request inquiry are provided the same call resolution in a timely manner. In addition, embodiments of the present invention provide a simplistic approach to determining a call resolution that the financial institution representatives can easily navigate. This straightforward approach insures consistency and efficiency, in that, the financial institution representative handling the call is only required to provide minimal inputs to complete the call resolution process and can thereby resolve the customer inquiry in a timely fashion.

An apparatus for standardizing the processing of financial institution customer calls defines first embodiments of the invention. The apparatus includes a computing platform including a memory and a processor in communication with the memory. The apparatus further includes a call advisor tool that is stored in the memory and executable by the processor. The call advisor tool is configured to present, during a call between a financial institution customer and a user, a display of a plurality of user interfaces. The user interfaces are configured to receive a series of user inputs that allow for the user to drill down from a general call category to a call-specific category that is responsive to one or more call requests made by the financial institution customer. In response to a user input that selects the call specific category, the user interfaces are configured to provide a display of a call resolution process that includes key points to be addressed during the call.

In specific embodiments of the apparatus, the call advisor tool is further configured to present the display of the plurality of user interfaces including an introductory user interface that is configured to include a plurality of general call script icons. Each icon is selectable, by user input, to present display of one or more suggested scripts associated with a topic of the key. In such embodiments of the apparatus, the general call script icons may include two or more of (a) a call greeting icon, (b) a caller verification icon, (3) a call branding icon, (4) a caller request inquiry icon, (5) an caller request acknowledgement icon, (6) an additional assistance inquiry icon and (6) a call closing icon. In other related embodiments of the apparatus, the call advisor tool is further configured to present the display of the introductory user interface that is configured to include a plurality of general call procedure icons, wherein each icon, is selectable, by user input, to present display of one or more key points to be addressed during the call associated with the general topic of the corresponding general call procedure icon.

In further specific embodiments of the apparatus, the call advisor tool is further configured to present the display of the plurality of user interfaces including a main menu interface that is configured to include a plurality of general call category icons, wherein each icon is selectable, by a user input, to present display of one or more call-specific categories. In such embodiments of the apparatus, each call-specific category may be selectable, by a user input, to present a display of the call resolution process that includes the key points to be addressed during the call. In further related embodiments of the apparatus, the call advisor tool is further configured to present the display of the plurality of user interfaces including the main menu interface that is configured to include a search engine and a search result window. The search engine is configured to receive a user input that defines search criteria associated with a call request and the search result window is configured to provide a display of one or more call-specific categories. Each call-specific category is selectable, by a user input, to present a display of the call resolution process that includes the key points to be addressed during the call. In still further related embodiments of the apparatus, the call advisor tool is further configured to display the main menu interface that is configured to display a calculator icon that is configured to be selectable, by a user input, to display a specialized calculator for calculating interest on an account.

Moreover, in further embodiments of the apparatus, the call advisor tool is further configured to present the display of the plurality of user interfaces including a call resolution interface that that is configured to present a display of the call resolution process that includes the key points to be addressed during the call and a procedure icon that is configured to be selectable, by user input, to provide access to a network-based solution center. In related embodiments of the apparatus the call resolution interface that is configured to include one or more of (1) an online banking simulator icon and mobile banking simulator icon that are selectable, by user input, to access a corresponding online banking application simulator and mobile banking application simulator and (2) a rewards icon that is selectable, by user input, to access a customer rewards redemption center.

A computer program product including a non-transitory computer-readable medium defines second embodiments of the invention. The computer-readable medium includes a set of codes for causing a computer to present, during a call between a financial institution customer and a user, a display of a plurality of user interfaces that are configured to (1) receive a series of user inputs that allow for the user to drill down from a general call category to a call-specific category that is responsive to one or more call requests by the financial institution customer, and, in response to a user input that selects the call specific category, (2) provide a display of a call resolution process that includes key points to be addressed during the call.

Thus, systems, apparatus, methods, and computer program products herein described in detail below provide standardizing call resolution of financial institution calls. A call advisor tool is described that insures that a consistent and efficient call resolution is provided each time a customer calls occurs. The call advisor tool provides for a simplistic approach to determining call resolution, such that the financial institution representatives can easily navigate and provide inputs to the tool to render a call resolution. The straightforward approach of the call advisor tool minimizes the inputs required of the financial institution representative to complete the call resolution process, resulting in decreases in call time.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram of an apparatus configured to provide standardizing call resolution of financial institution calls, in accordance with embodiments of the present invention;

FIG. 2 provides a more detailed block diagram of an apparatus configured to provide standardizing call resolution of financial institution calls, in accordance with present embodiments of the invention;

FIG. 3 provides an example of an introductory user interface of the call advisor tool, in accordance with present embodiments of the invention;

FIG. 4 provides a greeting script user interface accessible from the introductory user interface, in accordance with present embodiments of the invention;

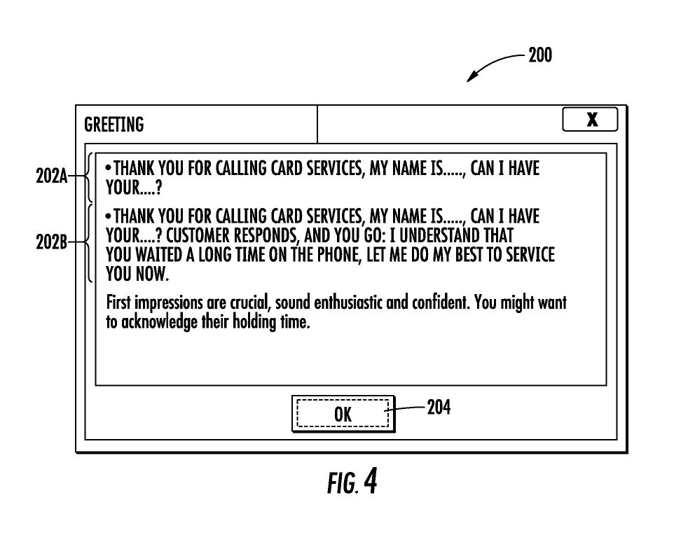

FIG. 5 provides an example of a main menu user interface included in the call advisor tool, in accordance with embodiments of the present invention;

FIG. 6 provides an example of a main menu user interface in which call-specific categories, in the form of status codes, are displayed in the search engine window in response to user selection of the status code icon, in accordance with embodiments of the present invention;

FIG. 7 provides an example of a call resolution user interface displayed in response to user selection of one of the status codes shown in FIG. 6, in accordance with embodiments of the present invention;

FIG. 8 provides an example of a main menu user interface in which call-specific payment categories, are displayed in the search engine window in response to user selection of the payment icon, in accordance with embodiments of the present invention;

FIG. 9 provides an example of a call resolution user interface displayed in response to user selection of one of the call-specific payment categories shown in FIG. 8, in accordance with embodiments of the present invention;

FIG. 10 provides an example of a main menu user interface in which a user has inputted search criteria in the search engine field, in accordance with embodiments of the present invention; and

FIG. 11 provides an example a call resolution user interface displayed in response to user inputting the search criteria shown in FIG. 10, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

According to embodiments of the invention described herein, various systems, apparatus, methods, and computer program products are herein described for standardizing call resolution of financial institution calls, specifically calls related to credit/debit cards, deposits or the like. The embodiments of the invention herein described insure that a consistent and efficient call resolution is provided each time a customer calls occurs. In this regard, customers who call with the same call request inquiry can be assured that they are being provided the same call resolution that they or any other caller would receive and that such call resolution is provided in a timely manner. In addition, embodiments of the present invention provide a simplistic approach to determining a call resolution that the financial institution representatives can easily navigate. This straightforward approach insures consistency and efficiency, in that, the financial institution representative handling the call is only required to provide minimal inputs to complete the call resolution process and can thereby resolve the customer inquiry in a timely fashion.

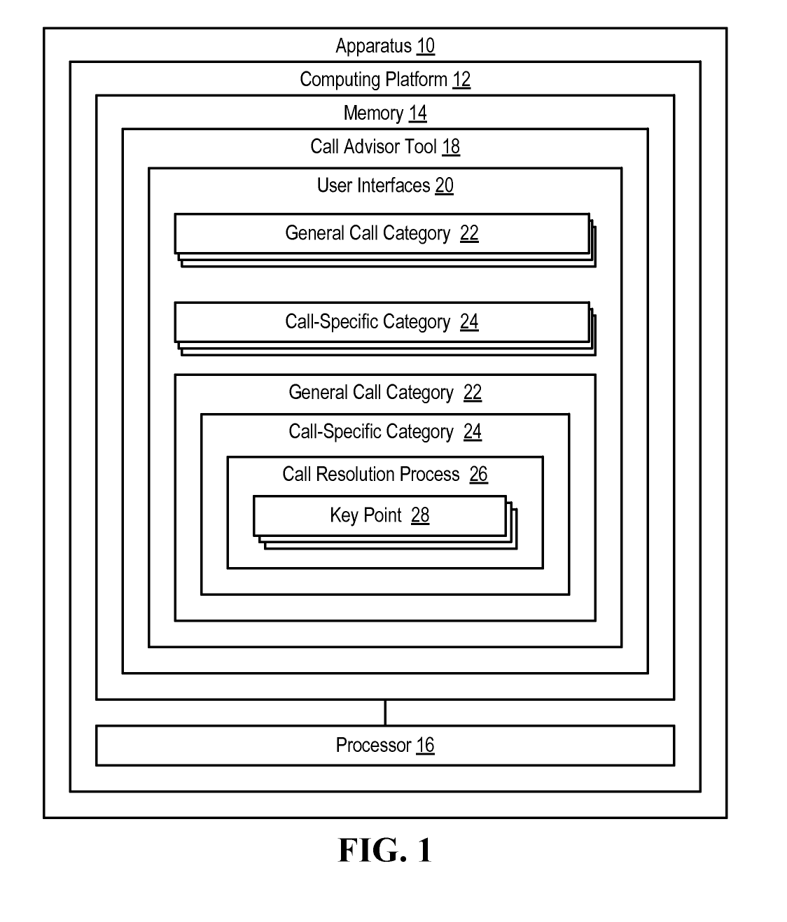

Referring to FIG. 1, a block diagram is presented of an apparatus 10 configured for providing standardizing call resolution of financial institution calls, specifically credit/debit card-related calls, deposit-related calls or the like, in accordance with embodiments of the present invention. The apparatus includes a computing platform 12 having a memory 14 and at least one processor 16 in communication with the memory 14. The memory 14 of apparatus 10 stores call advisor tool 18 that is implemented by a user (i.e., a financial institution representative, otherwise referred to as an associate, to assist the representative in determining how a call (e.g., telephone call, chat session or the like) should be resolved based on the call request/inquiry made by the customer/caller. The call advisor tool is configured to present to the user/financial institution representative, during a call between the user and a financial institution customer, a series of user interfaces 20. The user interfaces 20 are configured to receive user inputs from the user/financial institution representative that allow for the user to drill down from a selected one of a plurality of general call categories 22 to a selected one of a plurality of call-specific categories 24. For example, user interfaces 20 may be configured to display a plurality of general call categories 22, each of which may be selected by the user/financial institution representative based on the call request/inquiry being made by the customer caller. The general call categories 22 are broadly defined categories that account for general nature of the caller's request/inquiry. For example, in a credit/debit card-specific call advisor tool 18, the general call categories may include, but are not limited to, online banking, account status code, credit line, account interest, payments, authorized account users, account maintenance and the like. Once the user/financial institution representative has selected a relevant general call category 22, a user interface 20 will be presented to the user/financial institution representative that displays one or more call-specific categories 24. The call-specific categories 24 are more narrowly defined categories than the general call categories 22 and, as such, are more specific to the exact, or close to the exact, call of the customer request/inquiry.

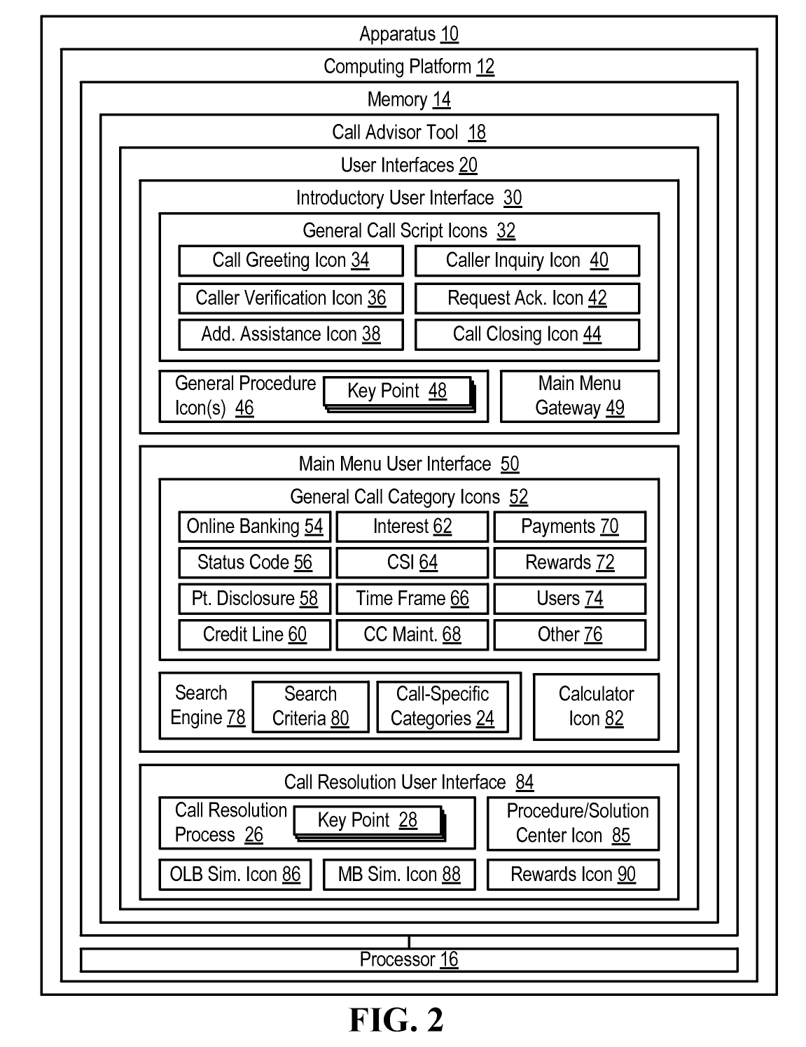

In response to a user input by the user/financial institution representative that selects one of the call specific categories 24, the call advisor tool 16 is configured to present a user interface 20 that displays a call resolution process 26 that includes a series of key points 28 that a user/financial institution representative is required to address during the call as a means of resolving the call. The key points 28 may be activities that need to be undertaken by the financial institution representative during the call and/or information that must be communicated to the caller during the call. In the event that the key points 28 do not address the caller's inquiry/request or if further instructions are required, the user interfaces 20 may optionally be configured to display a selectable option for accessing a more comprehensive network-based solution center (shown and described in relation to FIGS. 2, 7, 9 and 11) for further inquiry/request analysis.

Referring to FIG. 2, a block diagram is presented of an apparatus 10 configured to provide standardizing call resolution of financial institution calls, specifically credit/debit card-related calls, deposit-related calls or the like, in accordance with embodiments of the present invention. The apparatus 10 may include any type and/or combination of one or more computing devices. The apparatus 10 is operable to receive and execute modules, routines and applications, such as call advisor tool 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 2) that interfaces with any resident programs, such as call advisor tool 18 or the like, stored in the memory 14 of apparatus 10. Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of call advisor tool 18 obviating the need for such applications and modules to be stored in the memory.

As previously noted in relation to FIG. 1, memory 14 stores call advisor tool 18 that is configured to provide standardizing call resolution of financial institution calls, specifically credit/debit card-related calls, deposit-related calls or the like, in accordance with embodiments of the present invention. The call advisor tool is configured to present to the user/financial institution representative, during a call between the user and a financial institution customer, a series of user interfaces 20.

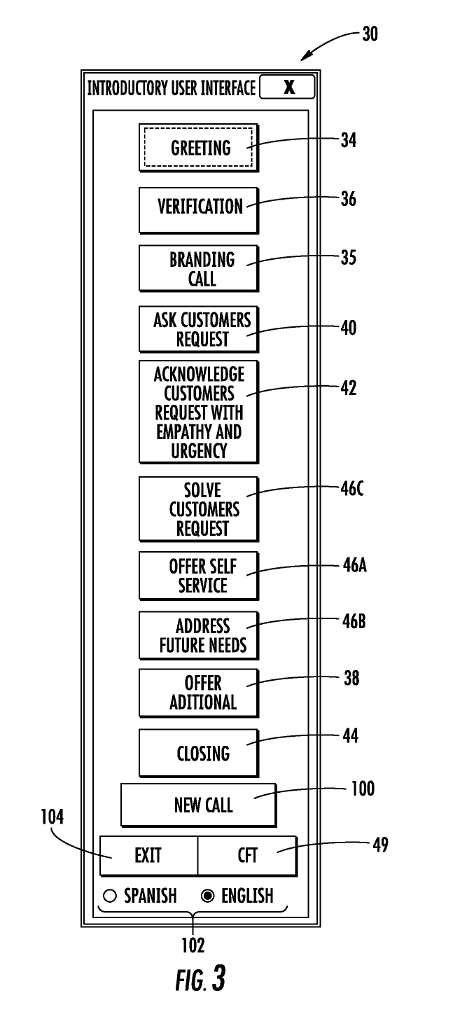

In specific embodiments of the invention, the user interfaces include an introductory user interface 30. A specific example of an introductory user interface 30 is shown and described in relation to FIG. 3, discussed infra. The introductory user interface 30 is configured to include a plurality a plurality of general call script icons 32. Each general call icon 32 is selectable, by user input, to present a user interface that displays one or more suggested scripts that are associated with the topic of the icon. The script topics are general to any call that may be received and/or handled by the user/financial institution representative. For example, in specific embodiment of the invention, the general call script icons may include, but are not limited to, call greeting icon 34, caller verification icon 36, additional assistance icon 38, call inquiry icon 40, request acknowledgement icon 42 and call closing icon 44. Each of these icons may be selected, by user input, to display one or scripts that a user/financial institution representative may choose to communicate (i.e., read) to the customer caller. Scripts may be pre-defined to include special language necessary to convey urgency or empathy toward the customer and/or the customer's current dilemma. Scripts become especially beneficial in instance in which the user/financial institution associate is communicating with the customer caller in a secondary language, in which the user/financial institution may be unfamiliar with the language necessary to assure that the proper the urgency, empathy or other emotion is conveyed to the customer.

Additionally, the introductory user interface 30 may be configured to include one or more general procedure icons 46. Each general procedure icon 46 is selectable, by user input, to present a user interface that displays one or more key points 48 that are associated with the topic of the icon. The general procedure topics are general to any call that may be received and/or handled by the user/financial institution representative. Moreover, the introductory user interface 30 may be configured to include a main menu gateway icon 49. The main menu gateway icon 49 is selectable, by user input, to present display of the main menu user interface 50, which is described in the following detailed discussion.

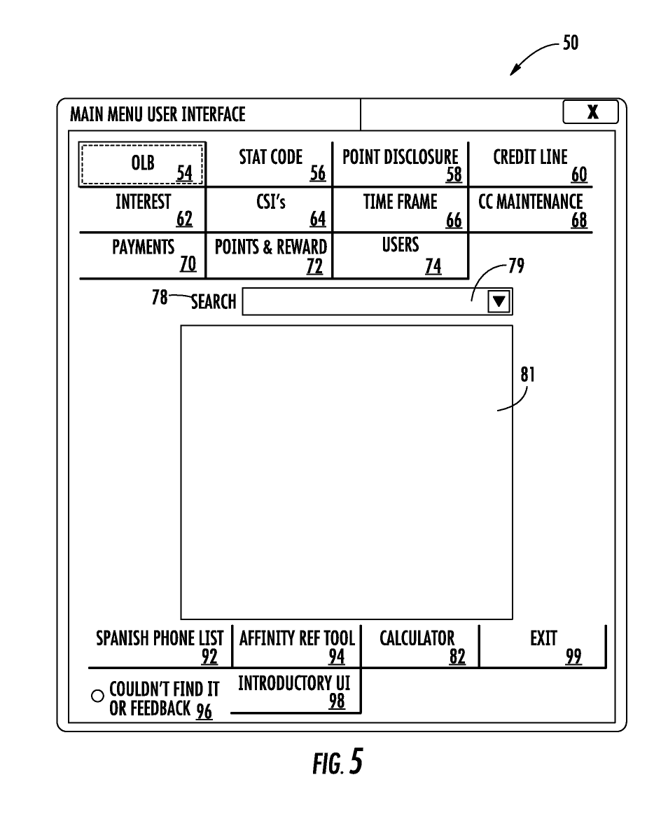

In further specific embodiments of the invention, the user interfaces include a main menu user interface 50. Specific examples of the main menu user interface 50 are shown in FIGS. 5, 6, 8 and 10, discussed infra. The main menu user interface 50 is configured to include a plurality a plurality of general call category icon 52. As previously noted, the general call categories are broadly defined categories that encompass the general nature of the caller's request/inquiry. In a specific embodiment in which the call advisor tool is implemented for credit/debit card-related calls, the general call category icons may include, but are not limited to, online banking icon 54, account status code icon 56, point/rewards disclosure icon 58, credit line icon 60, interest icon 62, CSI (e.g., miscellaneous category icon) icon 64, time frame icon 66, credit card maintenance icon 68, payments icon 70, rewards icon 72, authorized users icon 74 or any other general call category icon 76. The main menu user interface 50 is configured to receive a user input that selects one of the general call category icons 52 to provide display, either via the main menu user interface or another user interface, of call specific categories 24. The call specific categories 24 may be provided in list format or in other suitable format for display of such.

The main menu user interface 50 may additionally be configured to include a search engine 78. The search engine may be configured to receive a user input from the user/financial institution representatives that defines search criteria 80 based on the inquiry/request of the customer caller. The search engine may be configured to implement a drop down menu of frequently search terms and/or implement search words/terms suggestions based on currently inputted (i.e., typed) search content. In addition, the main menu user interface 50 may include a search result window (e.g., sub-user interface) (not shown in FIG. 2) that is configured to provide display of the call-specific categories 24 that are responsive to the search criteria 80. In additional embodiments, the search result window may also be configured to present display of the call-specific categories 24 in response to a user inputting selecting one of the displayed general category icons 52.

In other specific embodiments of the invention the main menu user interface 50 may include other selectable icons for providing the user/financial institution representative access to other functionality. For example, in certain embodiments, the main menu user interface 50 may include a calculator icon 82 that is configured to be selectable, by user input, to access a specialized calculator that is specially configured for calculating interest on customer accounts.

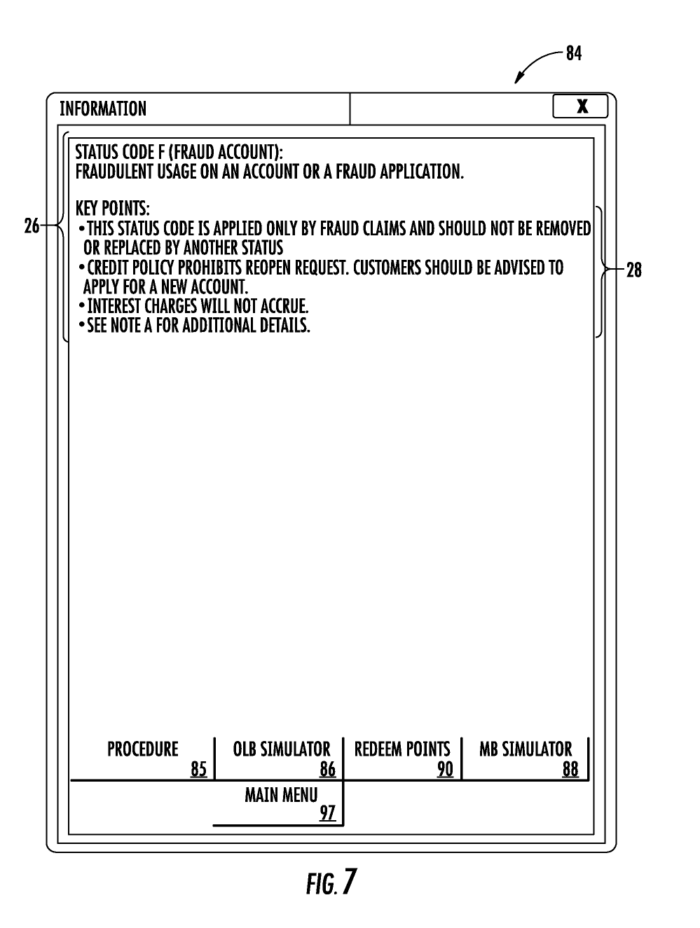

The call advisor tool 18 is further configured to provide a call resolution user interface 84. The call resolution user interface 84 is provided to the user/financial institution representative in response to the user selecting one of the call-specific categories 24 displayed in the main menu user interface 50 or any other user interface 20. Specific examples of the call resolution user interface 84 are shown in FIGS. 7, 9 and 11, discussed infra. The call resolution user interfaces 84 are configured to present a display of the call resolution process 26 that includes key points 28 that a user/financial institution representative is required to address during the call as a means of resolving the call. The key points 28 may be activities that need to be undertaken by the financial institution representative during the call and/or information that must be communicated to the caller during the call. The call resolution user interface 84 may additionally be configured to provide display of procedure/solution center icon 85 that is selectable, by user input, in the event that the key points 28 do not address the caller's inquiry/request or if further instructions are required. The procedure/solution center icon 85 may be configured to access a comprehensive network-based solution center for further inquiry/request analysis.

In additional embodiments of the call advisor tool 18, the call resolution user interface may be configured to provide display of an online banking simulator icon 86, a mobile banking simulator icon 88 and a rewards icon 90. The online banking and mobile banking simulator icon 86 and 88 provide the user financial institution representative access to online or mobile simulators, such that the user can answer specific questions related to those applications and/or simulate the caller's current activity experienced on those applications. The rewards icon 90 provides the user access to a rewards program for the purpose of answering caller requests/inquiries specific to the credit card's rewards program.

Referring to FIG. 3 an example of an introductory user interface 30 is shown. In accordance with embodiments of the present invention. The introductory user interface 30 includes a plurality of general call script icons 32, including call greeting icon 34, caller verification icon 36, branding call icon 35, ask customer request/caller inquiry icon 40, request acknowledgement icon 42, offer additional help icon 38 and call closing icon 44. The general call script icons 32 may be selected by a user/financial institution representative to display a script user interface. An example of a greeting script user interface 200 is shown in FIG. 3 and is displayed in response to the user selecting call greeting icon 34. The greeting script user interface 200 includes script 202A and script 2024, which are examples of greeting scripts that a user may use at the start of a call. Scripts such as those presented in greeting script user interface 200 may be instrumental in providing guidance to new financial institution representative during a training period or the like. In addition, greeting script user interface 200 includes “OK” icon 204 which is configured to close greeting script user interface 200 and return the user to the functionality of the introductory user interface 30.

Returning to FIG. 3, the introductory user interface 30 also includes call advisor gateway icon 49 that is configured to provide the user access to the main menu user interface 50. In addition, the introductory user interface 30 includes new call icon 100 that is selectable, by user input, to provide the user a new financial institution call and exit icon 104 that is selectable, by user input, to exit the call advisor tool. Moreover, introductory user interface 30 may include language options 102, for example, language options may include, but are not limited to, English and Spanish.

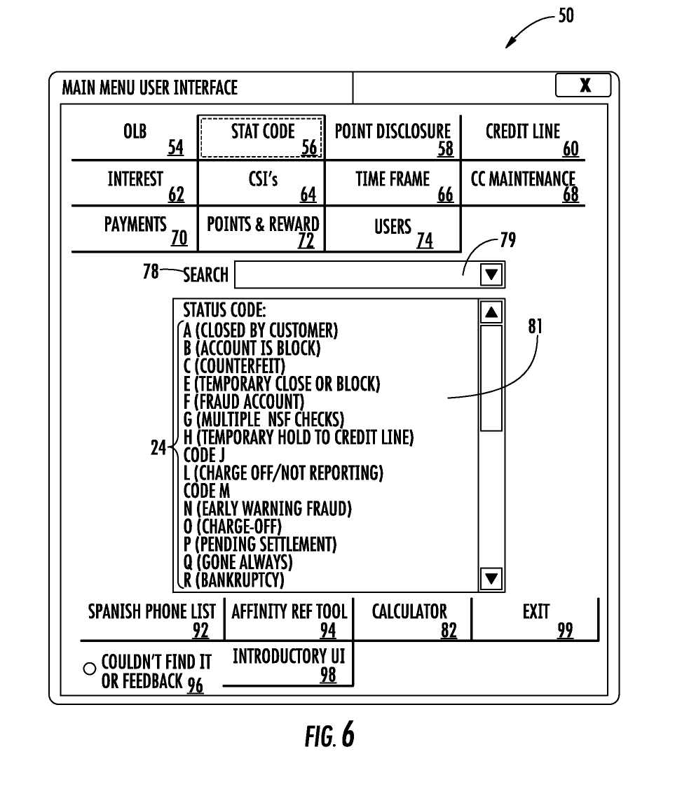

Referring to FIG. 5 an example of a main menu user interface 50 included in the call advisor tool, in accordance with embodiments of the present invention. The main menu user interface 50 includes a plurality of general call category icons 52 including, online banking icon 54, status code icon 56, points/rewards disclosure icon 58, credit line icon 60, interest icon 62, CSI icon 64, time frame icon 60, credit card maintenance icon 68, payment icon 70, points and rewards icon 72 and authenticated users icon 74. Each of the general call category icons 52 is selectable to provide display of call-specific categories, which are sub-categories within the corresponding general call category. For example, referring to FIG. 6, selection of the status code icon 56 provides for display of call-specific categories 24 within search engine window 81 or within a separate user interface (not shown in FIG. 6). In the illustrated example of FIG. 6, the call-specific categories 24 are a plurality of status codes which may be assigned to financial institution accounts. In the context of the call advisor tool, status codes may be currently assigned to an account which is the subject of the current call and the user/financial institution representative may be required to perform specific actions and/or communicate specific information to the customer (i.e., resolve the call), accordingly.

Referring to FIG. 7 shown is an example of a call resolution user interface 84 displayed in response to user selection of one of the status codes (i.e., call-specific categories 24) shown in FIG. 6. In the illustrated embodiment of FIG. 7, the user has selected status F from the list of status codes provided in the search engine window 81 and, in response to the selection, call resolution user interface 84 is displayed. Call resolution user interface 84 is configured to include a call resolution process 26 which provides the definition of the fraud code and key points 28 which are actions required to be performed by the user during the call and/or information that should be or is required to be communicated to the caller during the call. The call resolution user interface 84 additionally includes procedure/solution center icon 85 that is selectable, by user input, in the event that the key points 28 do not address the caller's inquiry/request or if further instructions are required. The procedure/solution center icon 85 may be configured to access a comprehensive network-based solution center for further inquiry/request analysis. Further, the call resolution user interface includes an online banking simulator icon 86, a mobile banking simulator icon 88 and a rewards icon 90. The online banking and mobile banking simulator icon 86 and 88 provide the user/financial institution representative access to online or mobile simulators, such that the user can answer specific questions related to those applications and/or simulate the caller's current activity experienced on those applications. The rewards icon 90 provides the user access to a rewards program for the purpose of answering caller requests/inquiries specific to the credit card's rewards program. The main menu icon 97 is selectable, by user input, to close the call resolution user interface 84 and return the user to the main menu user interface 50.

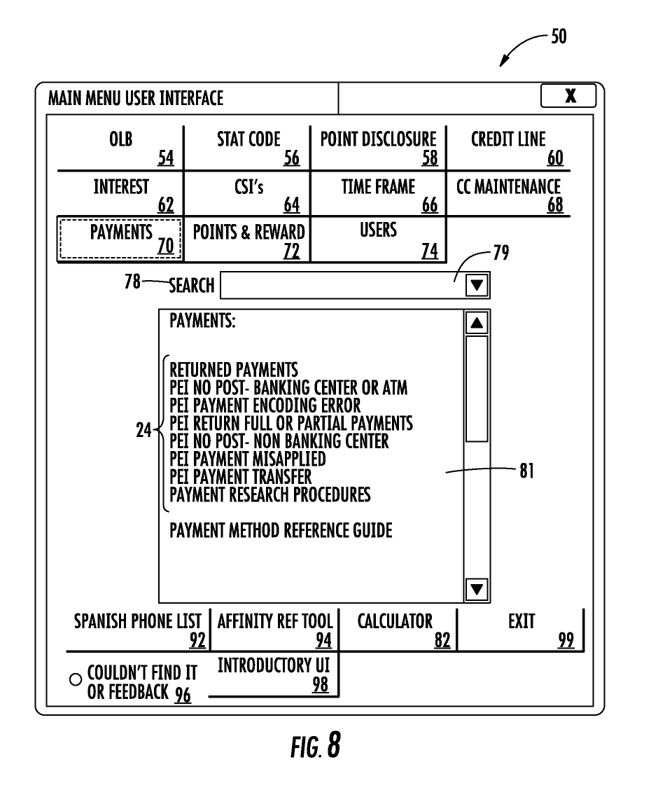

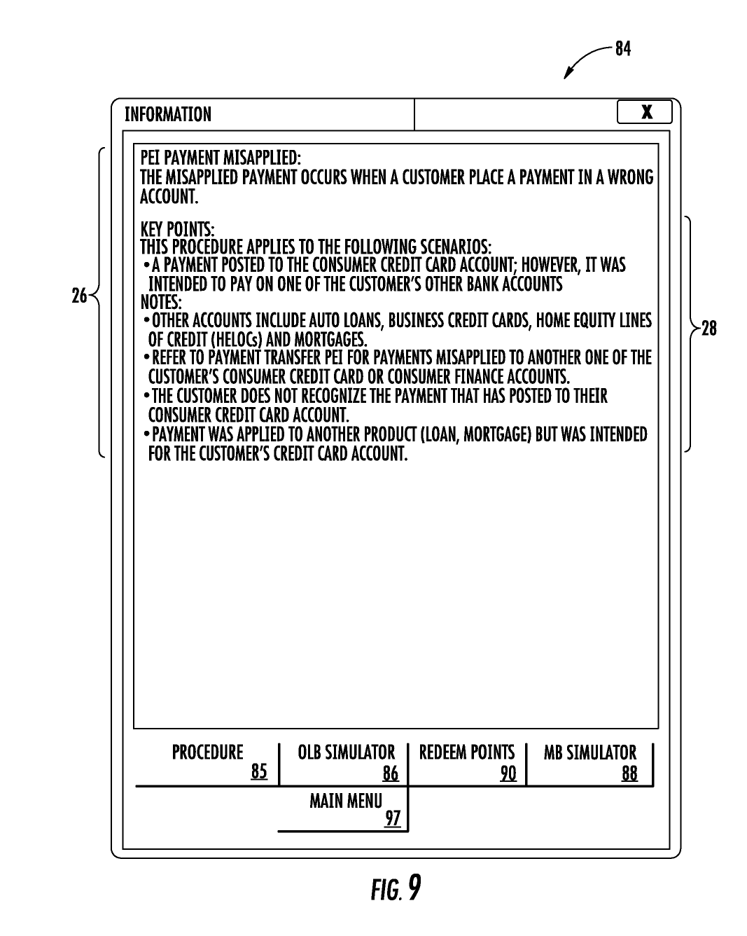

In yet another example, referring to FIG. 8, selection of the payments icon 70 provides for display of call-specific categories 24 within search engine window 81 or within a separate user interface (not shown in FIG. 8). In the illustrated example of FIG. 8, the call-specific categories 24 are payment sub-categories; each of which may applicable to the current call based on the caller inquiry/request and/or the status of the account pertaining to the call inquiry/request. Referring to FIG. 9 shown is an example of a call resolution user interface 84 displayed in response to user selection of one of the call-specific payment categories 24 shown in FIG. 8. In the illustrated embodiment of FIG. 9, the user has selected “PEI payment misapplied” from the list of payment categories provided in the search engine window 81 and, in response to the selection, call resolution user interface 84 of FIG. 9 is displayed. Call resolution user interface 84 is configured to include a call resolution process 26 which provides the definition of the payment category and key points 28 which are actions required to be performed by the user during the call and/or information that should be or is required to be communicated to the caller during the call.

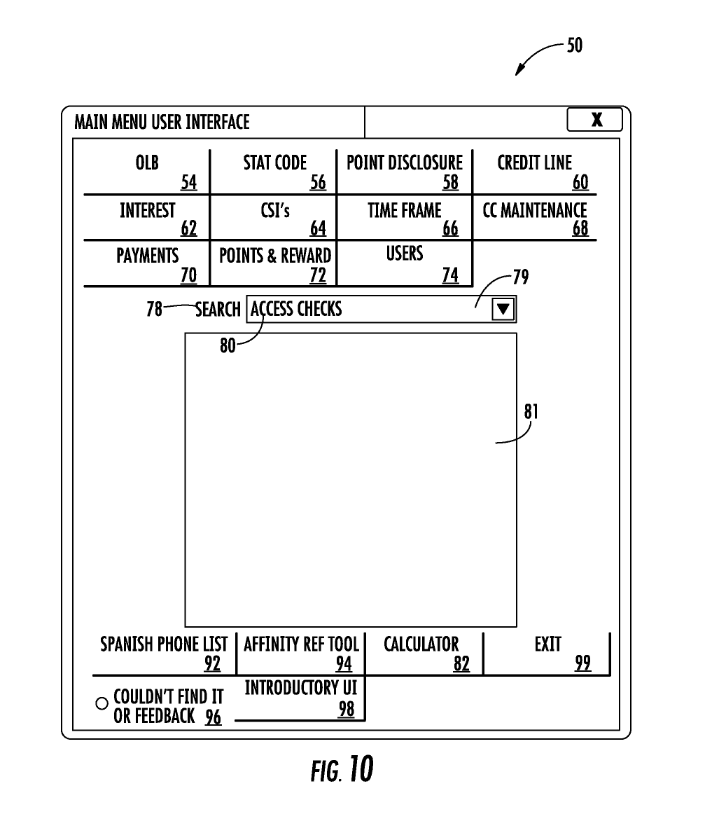

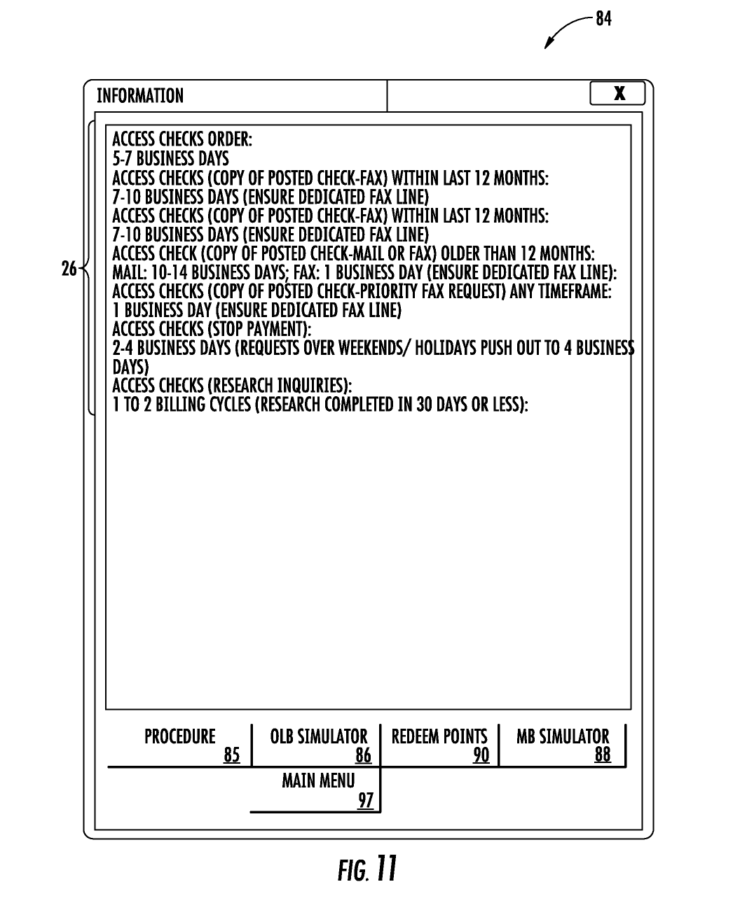

Referring to FIG. 10 an example of a main menu user interface 50 in which a user has inputted search criteria 80 in the search engine field 79. The search engine field 79 may implement a drop down menu configured to allow the user to choose the search criteria 80 or the user may provide user inputs in the search engine field 79. In the illustrated embodiment of FIG. 10, the search results are provided in the form of a call resolution. As such, the results of the search are provided in call resolution user interface 84, shown in FIG. 11, as opposed to providing the search results in search engine window 81 of FIG. 10. It should be noted that in other instances, the search criteria 80 will results in presentation of call-specific categories displayed in the search engine window 81. Referring to FIG. 11, the call resolution user interface 84 includes call resolution process 16 which includes the time in business days for access to checks.

Referring to FIGS. 5, 6, 8 and 10 the main menu user interface 50 also includes calculator icon 82 configured to be selected, by user input, to access and display a specialized calculator specifically designed for calculating interest. In addition, main menu user interface 50 includes Spanish phone list icon 92, and affinity reference tool 94. Spanish phone list icon 92 is configured to provide the user access to a listing, in Spanish, of financial institution telephone names/number which may be accessed by the user if the caller requires contact information in the Spanish language. Affinity reference tool 94 is configured to provide the user/financial institution representative, access to information regarding affinity programs associated with the financial institution in the event the caller expresses interest in affinity products or otherwise conveys an interest in an affinity (e.g., school, sports team, club, organization or the like). Moreover, main menu user interface 50 additionally is configured to include a radio button 96 for indicating that the user was unable to locate what they were looking for or to otherwise feedback on the call advisor tool. User selection of the radio 96 may trigger an email program to initiate an email addressed to a party of interest or provide for display of the email address of the party of interest. Further, main menu user interface 50 includes introductory icon 98 that is configured to return the user to the introductory user interface 30 and exit icon 99 that is configured to exit out of the call advisor tool.

Thus, systems, apparatus, methods, and computer program products described above provide for standardizing call resolution of financial institution calls. A call advisor tool is described that insures that a consistent and efficient call resolution is provided each time a customer calls occurs. The call advisor tool provides for a simplistic approach to determining call resolution, such that the financial institution representatives can easily navigate and provide inputs to the tool to render a call resolution. The straightforward approach of the call advisor tool minimizes the inputs required of the financial institution representative to complete the call resolution process, resulting in decreases in call time.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for standardizing the processing of financial institution customer calls, the apparatus comprising:
a computing platform including a memory and a processor in communication with the memory;
a call advisor tool stored in the memory, executable by the processor and configured to present, during a call between a financial institution customer and a user, a display of a plurality of user interfaces that are configured to (1) receive a series of user inputs that allow for the user to drill down from a general call category to a call-specific category that is responsive to one or more call requests by the financial institution customer, and, in response to a user input that selects the call specific category, (2) provide a display of a call resolution process that includes key points to be addressed during the call.

2. The apparatus of claim 1, wherein the call advisor tool is further configured to present the display of the plurality of user interfaces including an introductory user interface that is configured to include a plurality of general call script icons, wherein each icon is selectable, by user input, to present display of one or more suggested scripts associated with a topic of the icon.

3. The apparatus of claim 2, wherein the call advisor is further configured to present the display of the introductory user interface that includes a plurality of general call information icons, wherein the general call information icons include two or more of (a) a call greeting icon, (b) a caller verification icon, (3) a call branding icon, (4) a caller request inquiry icon, (5) an caller request acknowledgement icon, (6) an additional assistance inquiry icon and (6) a call closing icon.

4. The apparatus of claim 2, wherein the call advisor tool is further configured to present the display of the introductory user interface that is configured to include a plurality of general call procedure icons, wherein each icon, is selectable, by user input, to present display of one or more key points to be addressed during the call associated with the general topic of the corresponding general call procedure icon.

5. The apparatus of claim 1, wherein the call advisor tool is further configured to present the display of the plurality of user interfaces including a main menu interface that is configured to include a plurality of general call category icons, wherein each icon is selectable, by a user input, to present display of one or more call-specific categories.

6. The apparatus of claim 5, wherein the call advisor tool is further configured to present the display of the plurality of user interfaces including the main menu interface that is configured to include the plurality of general call category icons, wherein each icon is selectable, by the user, to present display of one or more call-specific categories, and wherein each call-specific category is selectable, by a user input, to present a display of the call resolution process that includes the key points to be addressed during the call.

7. The apparatus of claim 5, wherein the call advisor tool is further configured to present the display of the plurality of user interfaces including the main menu interface that is configured to include a search engine configured to receive a user input that defines search criteria associated with a call request and search result window configured to provide a display of one or more call-specific categories, and wherein each call-specific category is selectable, by a user input, to present a display of the call resolution process that includes the key points to be addressed during the call.

8. The apparatus of claim 1, wherein the call advisor tool is further configured to display the main menu interface that is configured to display a calculator icon that is configured to be selectable, by a user input, to display a specialized calculator for calculating interest on an account.

9. The apparatus of claim 1, wherein the call advisor tool is further configured to present the display of the plurality of user interfaces including a call resolution interface that that is configured to present a display of the call resolution process that includes the key points to be addressed during the call and a procedure icon that is configured to be selectable, by user input, to provide access to a network-based solution center.

10. The apparatus of claim 9, wherein the call advisor tool is further configured to present display of the call resolution interface that is configured to include (1) an online banking simulator icon and mobile banking simulator icon that are selectable, by user input, to access a corresponding online banking application simulator and mobile banking application simulator and (2) a rewards icon that is selectable, by user input, to access a customer rewards redemption center.

11. A computer program product comprising:
a non-transitory computer-readable medium comprising:
a set of codes for causing a computer to present, during a call between a financial institution customer and a user, a display of a plurality of user interfaces that are configured to (1) receive a series of user inputs that allow for the user to drill down from a general call category to a call-specific category that is responsive to one or more call requests by the financial institution customer, and, in response to a user input that selects the call specific category, (2) provide a display of a call resolution process that includes key points to be addressed during the call.

12. The computer program product of claim 1, wherein the set of codes is further configured to cause the computer to present the display of the plurality of user interfaces including an introductory user interface that is configured to include a plurality of general call script icons, wherein each icon is selectable, by user input, to present display of one or more suggested scripts associated with a topic of the icon.

13. The computer program product of claim 12, wherein the set of codes is further configured to cause the computer to present the display of the introductory user interface that includes a plurality of general call script icons, wherein the general call script icons include two or more of (a) a call greeting icon, (b) a caller verification icon, (3) a call branding icon, (4) a caller request inquiry icon, (5) an caller request acknowledgement icon, (6) an additional assistance inquiry icon and (6) a call closing icon.

14. The computer program product of claim 12, wherein the set of codes is further configured to cause the computer to present the display of the introductory user interface that is configured to include a plurality of general call procedure icons, wherein each icon, is selectable, by user input, to present display of one or more key points to be addressed during the call associated with the general topic of the corresponding general call procedure icon.

15. The computer program product of claim 12, wherein the set of codes is further configured to cause the computer to present the display of the plurality of user interfaces including a main menu interface that is configured to include a plurality of general call category icons, wherein each icon is selectable, by a user input, to present display of one or more call-specific categories.

16. The computer program product of claim 15, wherein the set of codes is further configured to cause the computer to present the display of the plurality of user interfaces including the main menu interface that is configured to include the plurality of general call category icons, wherein each icon is selectable, by the user, to present display of one or more call-specific categories, and wherein each call-specific category is selectable, by a user input, to present a display of the call resolution process that includes the key points to be addressed during the call.

17. The computer program product of claim 15, wherein the set of codes is further configured to cause the computer to present the display of the plurality of user interfaces including the main menu interface that is configured to include a search engine configured to receive a user input that defines search criteria associated with a call request and search result window configured to provide a display of one or more call-specific categories, and wherein each call-specific category is selectable, by a user input, to present a display of the call resolution process that includes the key points to be addressed during the call.

18. The computer program product of claim 11, wherein the set of codes is further configured to cause the computer to display the main menu interface that is configured to display a calculator icon that is configured to be selectable, by a user input, to display a specialized calculator for calculating interest on an account.

19. The computer program product of claim 11, wherein the set of codes is further configured to cause the computer to present the display of the plurality of user interfaces including a call resolution interface that that is configured to present a display of the call resolution process that includes the key points to be addressed during the call and a procedure icon that is configured to be selectable, by user input, to provide access to a network-based solution center.

20. The computer program product of claim 19, wherein the set of codes is further configured to cause the computer to display of the call resolution interface that is configured to include (1) an online banking simulator icon and mobile banking simulator icon that are selectable, by user input, to access a corresponding online banking application simulator and mobile banking application simulator and (2) a rewards icon that is selectable, by user input, to access a customer rewards redemption center.
